(19) United States
(12) Patent Application Publication
(10) Pub. No.: US 2006/0284388 A1
(43) Pub. Date: Dec. 21, 2006

(54) System and method for controlling vehicle equipment

(75) Inventors: Kazuhiro Nakashima, Obu-city (JP); Ifushi Shimonomoto, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/446,962

(22) Filed: Jun. 6, 2006

(30) Foreign Application Priority Data
Jun. 7, 2005 (JP) 2005-167403

(51) Int. Cl. B60G 17/00

(52) U.S. Cl. 280/6.152

(57) ABSTRACT

An in-vehicle device in a vehicle transmits a request signal and a portable device returns a response signal including an ID code. The in-vehicle device collates the ID code included in the response signal with a registration code stored therein. When the result of collating the ID code becomes OK, the in-vehicle device outputs a height decreasing signal to a vehicle height control device to decrease the height of the vehicle. Thus, the height of the vehicle is decreased at the time when a user holding the portable device gets in the vehicle or loads baggage, making it easier for users to get in the vehicle or to load baggage.

### CROSS REFERENCE TO RELATED APPLICATION

This application is based on and incorporates herein by reference Japanese Patent Application No. 2005-167403 filed on Jun. 7, 2005.

### FIELD OF THE INVENTION

This invention relates to a system and method for controlling vehicle-mounted equipment, in which an in-vehicle device in a vehicle collates an ID code obtained through mutual communication with a portable device, and controls the operation of vehicle-mounted equipment based on the collated result.

### BACKGROUND OF THE INVENTION

A system for controlling vehicle-mounted equipment has heretofore been known as disclosed in, for example, JP-A-2000-104429. In this system, vehicle doors are locked or unlocked based on the result of collation of an ID code obtained through mutual communication between a potable electronic key (portable device) and an in-vehicle device in the vehicle. Further, a steering wheel is unlocked and an engine is permitted to be started when a user who holds the portable device is in a vehicle compartment.

The in-vehicle device in the vehicle includes exterior transmitters for transmitting request signals to the portable device, an interior transmitter, a receiver for receiving a response signal from the portable device, and an electronic control unit (ECU) for controlling vehicle-mounted equipment such as doors based on the results of transmission and reception to and from the portable device. The exterior transmitters and the interior transmitter have communication areas where mutual communication is possible with the portable device in a predetermined range around the vehicle and inside the compartment, respectively. This makes it possible to detect a user holding the portable device who is approaching the vehicle, getting in the vehicle or getting off the vehicle.

For example, when the user holding the portable device approaches the vehicle to get in the vehicle, and enters into the area communicable with the exterior transmitters, the portable device transmits a response signal inclusive of an ID code to the in-vehicle device in the vehicle in response to request signals. When it is determined that a predetermined relationship is satisfied such as that the ID code obtained from the portable device is in agreement with the registered ID code, the in-vehicle device in the vehicle sends a control signal to a door-locking unit which is included in the vehicle-mounted equipment so as to unlock the doors.

When the user holding the portable device gets on the vehicle causing the area communicable with the portable device to be moved into the compartment from outside the compartment, the in-vehicle device in the vehicle unlocks the steering wheel and permits the engine to be started as a control operation for the vehicle-mounted equipment depending upon the result of collation of the ID code.

According to this system, the user holding the portable device is allowed to unlock the doors without actually holding the portable device in hand and to easily get in the vehicle.

However, some vehicles may have a height which is relatively high and passengers may feel it not easy to get in the vehicle. Besides, when the passenger opens the rear door of the vehicle to load the vehicle with baggage, it will be experienced with many vehicles that the opening position is considerably high when the rear door is opened. Therefore, when the baggage to be loaded is heavy, a lot of work is necessary to load the baggage.

### SUMMARY OF THE INVENTION

It is an object of the present invention to provide a system and method for controlling vehicle-mounted equipment which makes it easier to get in the vehicle or to load the vehicle with baggage than the conventional vehicles.

According to a vehicle system of the present invention, an in-vehicle device provided in a vehicle and a portable device carried by a user communicate each other to control vehicle-mounted equipment including a height adjusting device, which adjusts a height of a vehicle.

In one aspect, the height adjusting device is driven to decrease the height of the vehicle from an initial position before the user of the portable device gets in the vehicle, when the portable device is determined to be an authorized one. In another aspect, the height adjusting device is driven to decrease the height of the vehicle from the initial position, when an engine is stopped.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic illustration showing a system for controlling vehicle-mounted equipment according to a first embodiment;

FIG. 2 is a flowchart showing a control operation at the time of getting in a vehicle, such as unlocking doors and decreasing a vehicle height based on a result of collation of an ID code obtained through mutual communication between an in-vehicle device in the vehicle and a portable device;

FIG. 3 is a flowchart showing control processing for increasing the vehicle height at the time of getting in the vehicle;

FIG. 4 is a flowchart showing a control operation at the time of getting in the vehicle according to a second embodiment;

FIG. 5 is a flowchart showing a control operation at the time of getting in the vehicle according to a third embodiment; and

FIG. 6 is a flowchart showing a control operation at the time of getting off the vehicle for decreasing the vehicle height when the vehicle has come into a halt according to a fourth embodiment.

### DETAILED DESCRIPTION OF THE PREFERRED EMBODIMENTS

### First Embodiment

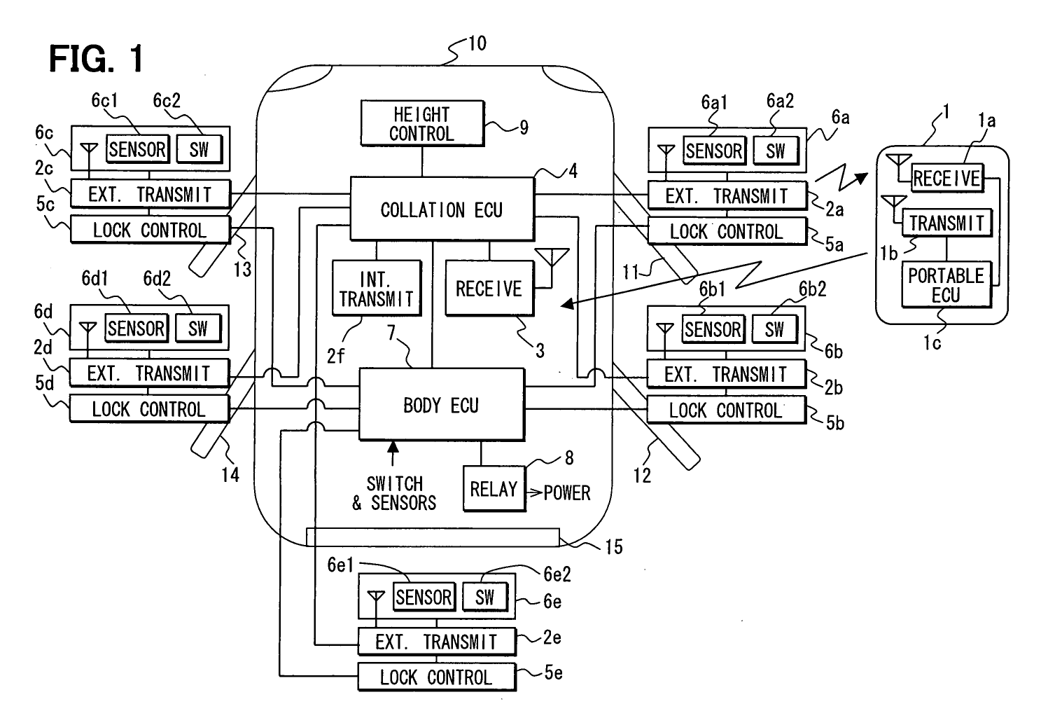

A system for controlling vehicle-mounted equipment according to a first embodiment is shown in FIG. 1. This system controls the locked/unlocked state of vehicle doors based on a result of collation of an identification (ID) code obtained through mutual communication between a portable device (electronic key) 1 carried by a user such as a driver and an in-vehicle device in a vehicle 10. The in-vehicle device controls the height of the vehicle 10 to make it easy to get in the vehicle 10 or to facilitate the operation for loading baggage.

The portable device 1 includes a receiver 1a for receiving a request signal from exterior transmitters 2a to 2e or from an interior transmitter 2f in the in-vehicle device in the vehicle 10, and a transmitter 1b for transmitting a response signal inclusive of an ID code in response to the reception of the request signal. A portable device ECU 1c is connected to the receiver 1a and to the transmitter 1b, and executes various control processing. Specifically, the portable device ECU 1c determines the reception of request signals based on a reception signal of the receiver 1a, or forms a response signal inclusive of the ID code in response to the request signal and transmits it from the transmitter 1b.

The in-vehicle device in the vehicle includes the exterior transmitters 2a to 2e provided for the doors 11 to 15 of the vehicle 10, and the interior transmitter 2f provided in the compartment. The exterior transmitters 2a to 2e and the interior transmitter 2f transmit request signals based on a transmission instruction signal from a collation ECU 4 in the in-vehicle device.

The distance which the request signals can reach from the exterior transmitters 2a to 2e is set to be, for example, about 0.7 to about 1.0 m. When the vehicle 10 is parked in a state where the doors 11 to 15 are locked, the communication areas are formed around the doors 11 to 15 of the vehicle 10 depending upon the distance the request signals can reach. Thus, a user holding the portable device 1 can be detected when he/she has approached the vehicle 10. The communication area by the interior transmitter 2f is so set as to cover the interior of the compartment, and detects whether the portable device 1 is in the compartment. The interior transmitters 2f may be provided in a plural number, so that the total communication areas thereof cover the interior of the compartment.

Further, the in-vehicle device in the vehicle includes a receiver 3, which is provided in the compartment of the vehicle 10, is placed in a state to receive a response signal in synchronism with the output of a transmission instruction signal to the transmitters 2a to 2f, and receives the response signal transmitted from the portable device 1. The response signal received by the receiver 3 is output to the collation ECU 4. The collation ECU 4 collates whether the ID code included in the response signal that is received satisfies a predetermined relation, such as whether the ID code included in the response signal that is received is in agreement with a registration code that has been registered in advance. Depending upon the result of collation, the collation ECU 4 outputs a control signal to a body ECU 7 to control the locked/unlocked state of the doors.

The body ECU 7 controls supply of electric power to the equipment mounted on the vehicle 10 or to discontinue the power supply depending upon the operation of the engine switch, and outputs drive signals to lock control units 5a to 5e provided in the doors 11 to 15 to control the locked/unlocked state of the doors 11 to 14 of the vehicle. When the body ECU 7 supplies the electric power to the equipment mounted on the vehicle, a relay circuit 8 is driven, and the electric power is supplied from a battery (not shown) to the equipment mounted on the vehicle via the relay circuit 8. The body ECU 7 receives signals from an engine switch and from various sensors such as seat sensors that detect passengers who have got in the vehicle.

Further, the in-vehicle device in the vehicle includes lock control units 5a to 5e that are provided in the doors 11 to 15 of the vehicle 10 to lock and unlock the doors 11 to 15. Specifically, the lock control units 5a to 5e have door lock motors that rotate forward/reverse depending upon a locking/unlocking signal transmitted from the body ECU 7. The doors 11 to 15 of the vehicle are locked or unlocked depending upon the turn of the door lock motors.

Door handles 6a to 6e of the doors 11 to 15 of the vehicle 10 are provided with touch sensors 6a1 to 6e1 to detect a user holding the portable device 1 who has operated the door handles 6a to 6e upon touching the door handles 6a to 6e. When the operation of the door handles 6a to 6e is detected, the doors 11 to 15 are unlocked. The door handles 6a to 6e are further provided with door lock switches 6a2 to 6e2 constructed as push switches. The doors 11 to 15 are locked upon operating the door lock switches 6a2 to 6e2. Further, the door handles 6a to 6e are constructed to operate as antennas of the exterior transmitters 2a to 2e.

For the passenger such as the user holding the portable device 1 to easily get in the vehicle 10 or for easily loading the baggage, the collation ECU 4 outputs a vehicle height control signal to a vehicle height control unit 9 depending upon a result of collation of the ID code when the vehicle is parked. When the collation ECU 4 outputs the vehicle height control signal, the body ECU 7 supplies the electric power to the vehicle height control device 9 so as to adjust the vehicle height.

The vehicle height control device 9 is constructed with actuators which are provided in the wheels of the vehicle to adjust the height of the vehicle, a vehicle height sensor for detecting the vehicle height, and a control unit for controlling the vehicle height by driving the actuators upon determining the vehicle height.

The actuator may be constructed with an air compressor which generates compressed air necessary for increasing the vehicle height, a chamber working as a pneumatic spring provided integrally with a shock absorber, and a valve for feeding the compressed air formed by the compressor into the chamber and for discharging the air out of the chamber. The actuator may be the one for adjusting the vehicle height by using, for example, a hydraulic pressure in addition to the one that adjusts the vehicle height by using the compressed air.

In addition to varying the vehicle height depending upon the vehicle height control signal from the collation ECU 4, the vehicle height control device 9 executes an automatic leveling control to maintain the vehicle height constant irrespective of the number of the passengers or the payload as well as a high speed-sensing control for enhancing the traveling stability by decreasing the vehicle height and by suppressing the air resistance and lift when traveling at high speeds.

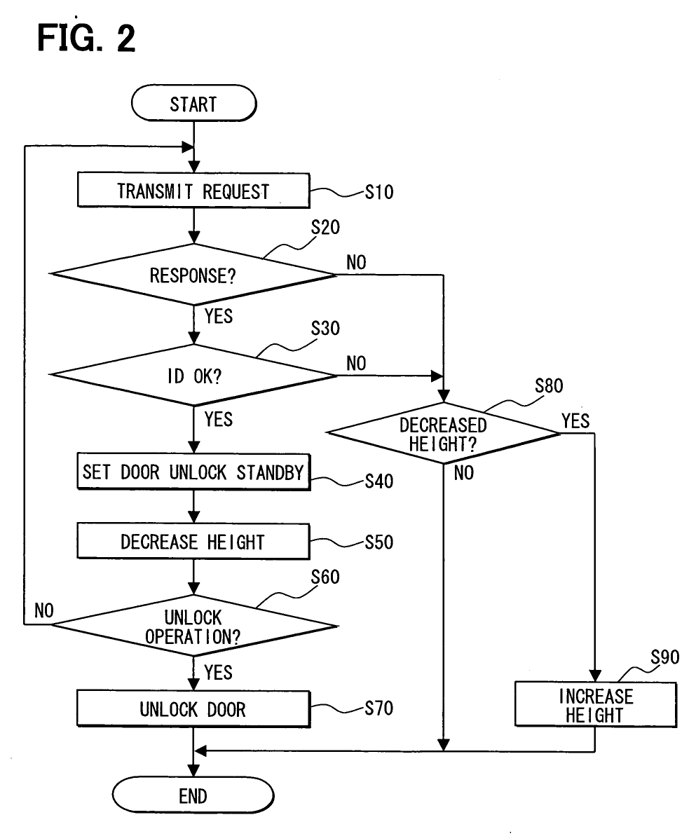

The collation ECU 14 and the body ECU 7 may be programmed to operate, as shown in FIG. 2, to unlock the doors 11 to 15 and to decrease the vehicle height for easy getting-in based on a result of collation of an ID code obtained through the mutual communication between the in-vehicle device in the vehicle and the portable device 1. Here, the processing illustrated in the flowchart of FIG. 2 is executed at regular intervals. That is, when the vehicle 10 is in a parked condition in a state where its engine is held stopped and the doors 11 to 15 are held locked, the ECU 4 instructs the exterior transmitters 2a to 2e to transmit request signals at regular intervals to make sure if the user holding the portable device 1 has approached the vehicle 10.

First, at step S10, a transmission instruction signal is output to the exterior transmitters 2a to 2e, so that request signals are transmitted from the exterior transmitters 2a to 2e. At step S20, it is determined if a response signal is received from the portable device 1 in response to any of the request signals. When no response signal is received, it is so regarded that the portable device 1 is not in the communication areas of the exterior transmitters 2a to 2e, and the routine proceeds to processing of step S80. When the response signal is received from the portable device 1, on the other hand, the routine proceeds to processing of step S30.

Here, it is so constructed that the exterior transmitters 2a to 2e transmit request signals including identification codes specific to the exterior transmitters 2a to 2e, and the portable device 1 returns the response signals including the identification codes. Alternatively, the collation ECU 4 instructs the transmitters 2a to 2e to transmit request signals in order at timings that are different one another. This enables the collation ECU 4 to identify which of the transmitters 2a to 2e has transmitted the request signal causing the portable device 1 to return the response signal in response thereto. Namely, it is made possible to identify which of the vehicle doors 11 to 15 is being approached by the user who carries the portable device 1.

At step S30, it is determined whether a predetermined relationship is satisfied, such as whether the ID code included in the response signal is in agreement with the ID code that has been registered in advance (result of collation of ID code is OK/NG). When the result of collation of the ID code is determined to be OK (authorized user) in this determination processing, the routine proceeds to step S40. When the result of collation of the ID code is determined to be NG (unauthorized user), the routine proceeds to the processing of S80.

At step S40, first, the position of any one of the exterior transmitters 2a to 2e to which the portable device 1 has responded is determined from the identification code included in the response signal or from the timing of receiving the response signal. The positions of the transmitters 2a to 2e are corresponding to the positions of the vehicle doors 11 to 15 to which the user holding the portable device 1 is approaching. The collation ECU 4 drives the touch sensors 6a1 to 6e1 of the vehicle doors 11 to 14 to which the user holding the portable device 1 is approaching to render the vehicle door 11 to 15 to be placed in the unlock standby state.

At subsequent step S50, a vehicle height decreasing signal is output to the vehicle height control device 9 to be ready for the passenger such as the user holding the portable device 1 to get in the vehicle or for loading baggage. Therefore, the height of the vehicle decreases, and the passenger is allowed to easily get in the vehicle or to load baggage through the rear door.

At step S60, it is determined whether the unlocking operation by the user holding the portable device 1 who touches or grips any one of the door handles 6a1 to 6e1 is detected in any one of the doors 11 to 15 which are in the unlock standby state and are approached by the user holding the portable device 1. In the doors 11 to 15 approached by the user holding the portable device 1, the touch sensors 6a1 to 6e1 in the door handles 6a to 6e are energized and are made to be capable of detecting the door handles 6a to 6e gripped by the user holding the portable device 1. When the detection signals are sent to the collation ECU 4 from the touch sensors 6a1 to 6e1, it is so determined that the unlock operation is detected.

When the unlocking operation is not detected, the routine stands by until the unlocking operation is detected. When the unlocking operation is not detected even after the passage of a predetermined period of time, the processing is executed again starting with step S10.

When it is determined at step S60 that the unlocking operation is detected, the routine proceeds to step S70 to unlock the doors 11 to 15 of the vehicle. Therefore, the passenger such as the user holding the portable device 1 is allowed to unlock and open the doors 11 to 15 of the vehicle without any particular additional operation. When getting in the vehicle or loading baggage, the vehicle height has been decreased to be lower than the ordinary vehicle height (initial position) facilitating an attempt of getting in the vehicle or loading baggage.

In the above embodiment, further, the vehicle height is adjusted at a moment when the result of collating the ID code proves to be OK, i.e., before the passenger attempts to get in the vehicle. Therefore, the vehicle is placed in a state where the vehicle height has been decreased to a sufficient degree before, for example, the user holding the portable device 1 gets in the vehicle.

When the vehicle height is decreased based only upon the result of collating the ID code, however, it may often happen that the vehicle height is decreased even when the user holding the portable device 1 simply passes by the vehicle. When the user holding the portable device 1 does not actually get in the vehicle or does not load baggage, it is desired that the vehicle height is not left to stay in the decreased position but is increased to the initial position. Therefore, it is determined whether the vehicle is in the state where the vehicle height has been decreased, when no response signal is received from the portable device 1 or at step S80 that is executed when the result of collating the ID is NG. When the determination is “yes” in the determination processing, a vehicle height increasing signal is output to the vehicle height control device 9 at step S90 to lift the vehicle height up to the initial position.

That is, the fact that the user holding the portable device 1 is away from the vehicle is determined from the reception of a response signal with which the result of collation of the ID code becomes OK. This is because as the user holding the portable device 1 separates away from the vehicle, mutual communication can no longer be sustained between the in-vehicle device in the vehicle and the portable device 1, and there is received no response signal with which the result of collation of the ID code becomes OK. When it is regarded that the user holding the portable device 1 is away from the vehicle, the vehicle height is increased up to the initial position.

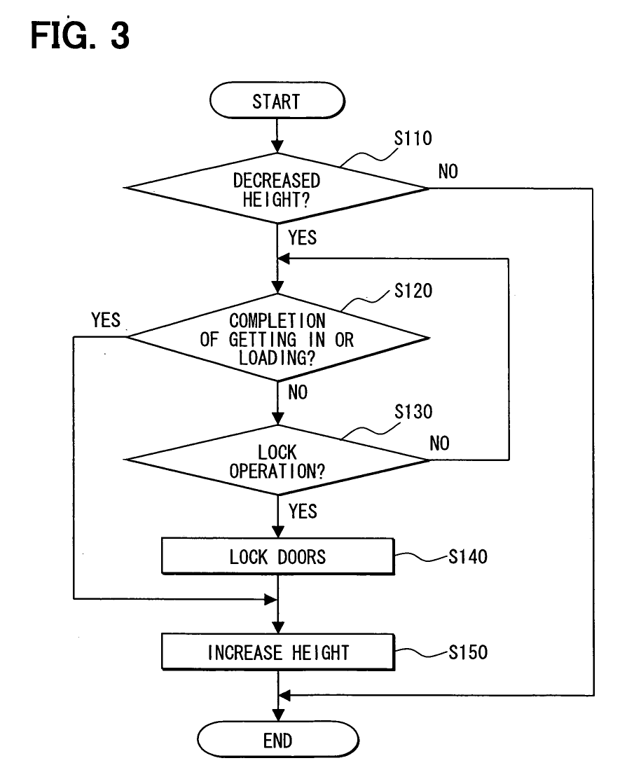

When the control operation is executed at the time of getting in as described above, it becomes necessary to increase the height of the vehicle up to the initial position after having got in the vehicle or after having loaded baggage. This control processing for increasing the vehicle height after getting in the vehicle or loading baggage may be attained as shown in FIG. 3.

At step S110, it is determined whether the vehicle is in a state where the height thereof has been decreased. When the determination is “no” in the determination processing, the process readily ends. When the determination is “yes” on the other hand, the routine proceeds to processing at step S120.

At step S120, it is determined whether the passenger has got in the vehicle. In the processing for determining whether the passenger has completed getting in, the determination is so rendered that the passenger has got in when, for example, it may be detected by seat switches provided in the seats of the vehicle that a passenger has seated on at least the driver's seat. It may alternatively be detected by, for example, courtesy lamp switches that respond to the doors 11 to 15. Further, the engine that has started may be added as a requirement for determining that the passenger has got in.

In determining whether the passenger has got in at step S120, when it is determined that the passenger has got in the vehicle, the routine proceeds to step S150 where the vehicle height increasing signal is output to the vehicle height control device 9 to lift the height of the vehicle. When it is determined that the passenger is not getting in the vehicle, on the other hand, the routine proceeds to step S130.

At step S130, it is determined whether the door lock switches 6a2 to 6e2 provided in the doors 11 to 15 are operated. When it is determined at step S130 that the door lock switches 6a2 to 6e2 are operated, a lock signal is output at step S140 to the lock control units 5a to 5e to lock the doors 11 to 15. At step S150, further, a vehicle height increasing signal is output to the vehicle height control unit 9 to lift the vehicle height up to the initial position.

Upon increasing the vehicle height depending upon the door lock operation as described above, the vehicle height can be quickly returned to the initial position when, for example, the rear door 15 is opened to load the vehicle with baggage and is closed and locked after having loaded baggage, or when the vehicle doors 11 to 14 are once unlocked in an attempt to get in the vehicle but are soon locked again as a result of giving up the attempt of getting in.

### Second Embodiment

A second embodiment is similar to the first embodiment. However, in the second embodiment, the vehicle height is decreased and the doors 11 to 15 are unlocked after the result of collating the ID code becomes OK and the unlocking operation is executed.

Therefore, upon simply touching and gripping the door handles 6a to 6e provided for the doors 11 to 15, the doors 11 to 15 of the vehicle can be unlocked and the height of the vehicle can be decreased further facilitating the attempt for getting in the vehicle and loading baggage. In particular, when the door handles 6a to 6e are gripped by the user holding the portable device 1, the user is allowed to reliably get in the vehicle and to load baggage. Therefore, the control operation for decreasing the vehicle height can be executed only when it is required to decrease the vehicle with a trigger by the operation for unlocking the door handles 6a to 6e.

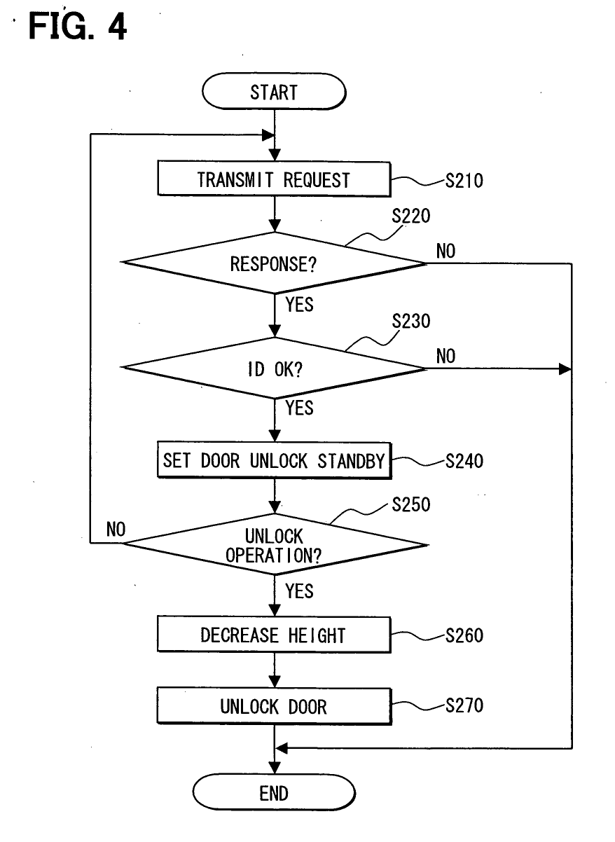

The control operation at the time of getting in the vehicle according to this embodiment maybe attained as shown in FIG. 4. Here, the processing from step S210 to S240 in FIG. 4 are the same as the processing from S10 to S40 in the flowchart of FIG. 2.

At step S250, whether the user holding the portable device 1 has touched the door handles 6a to 6e to effect the unlocking operation is detected based upon detection signals from the touch sensors 6a1 to 6e1. When it is determined at step S250 that the unlocking operation is detected, the routine proceeds to step S260 where a vehicle height decreasing signal is output to the vehicle height control device 9 to decrease the vehicle height. At step S270, further, the doors 11 to 15 of the vehicle are unlocked.

According to the above processing of this embodiment, the vehicle height is decreased and, nearly at the same time, the doors 11 to 15 are unlocked when the result of collating the ID code is determined to be OK and when it is determined that the unlocking operation is detected.

In this embodiment, the vehicle height is not decreased even when the user holding the portable device 1 simply passes by the vehicle 10. Unlike the processings at steps S80 and S90 in the flowchart of FIG. 2, therefore, there is no need of determining the state where the vehicle height has been decreased or executing the processing for increasing the vehicle height.

### Third Embodiment

A third embodiment is also similar to the first embodiment and the second embodiment. In the first and second embodiments, the request signals are repetitively transmitted at predetermined time intervals from the exterior transmitters 2a to 2e when the vehicle 10 is parking in a state where the doors 11 to 15 are locked. In the third embodiment, on the other hand, the exterior transmitters 2a to 2e transmit the request signals only when the unlocking operation is executed by the user holding the portable device 1. When a response signal is received in response to the request signal and when the result of collating the ID code included therein is OK, the vehicle height is decreased and the doors 11 to 15 of the vehicle 10 are unlocked.

This makes it possible to decrease the number of times the request signals are transmitted from the exterior transmitters 2a to 2e, and to decrease the consumption of electric power. Further, upon being triggered by the unlocking operation, the control operation for decreasing the vehicle height is effected only when it is necessary to decrease the vehicle height.

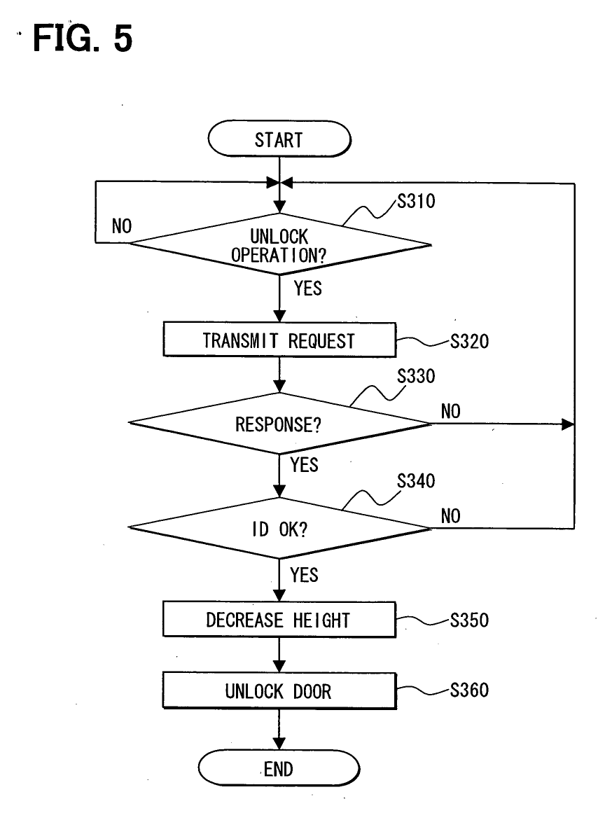

The control operation according to the embodiment may be attained as shown in FIG. 5. First, whether the user holding the portable device 1 has touched the door handles 6a to 6e to effect the unlocking operation is determined based upon the detection signals of the touch sensors 6a1 to 6e1. When it is determined in the determination processing of step S310 that the unlocking operation has not been effected, the subsequent processing is not executed, and the routine stands by until the unlocking operation is detected.

Thus, upon executing the processing for determination, first, whether the unlocking operation is effected at the time of getting in the vehicle, the request signals are transmitted from the exterior transmitters 2a to 2e only when the unlocking operation is effected.

The processing of steps S320 to S340 are the same as the processings of steps S10 to S30 of the flowchart of FIG. 2, and the processings of steps S350 and S360 are the same as the processings of steps S50 and S70 of the flowchart of FIG. 2.

At the time of getting in the vehicle, too, the processing of steps S80 and S90 in FIG. 2 are omitted from the flowchart of FIG. 2. This is because the request signals are transmitted only when the unlocking operation is detected. Like in the second embodiment, therefore, the control operation for decreasing the vehicle height is not executed even when the user holding the portable device 1 simply passes by the vehicle.

### Fourth Embodiment

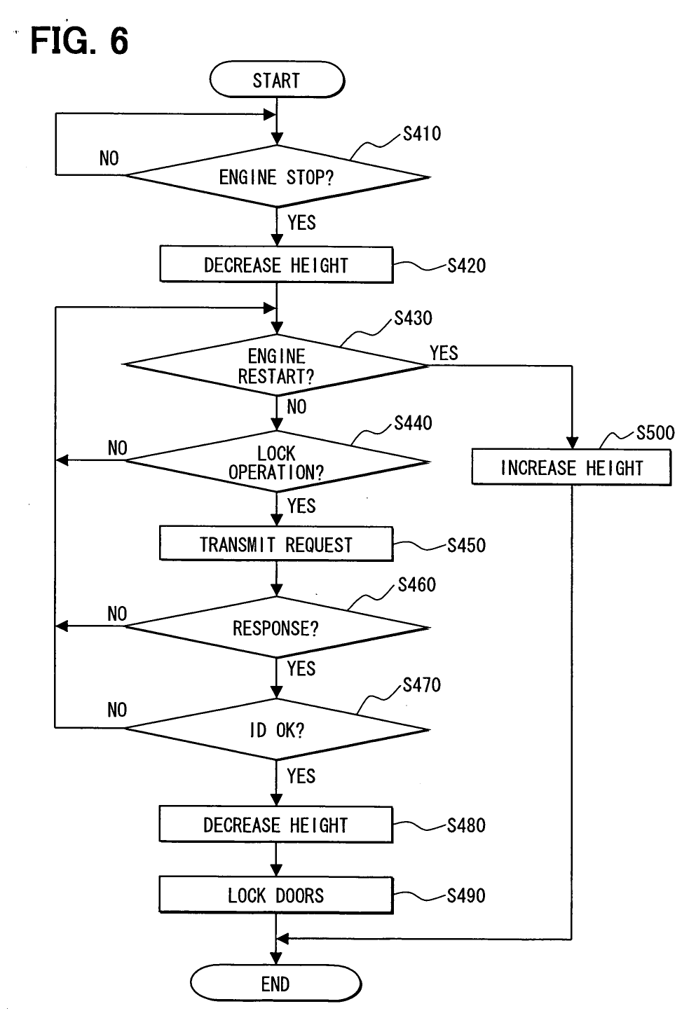

A fourth embodiment may be combined with the first to third embodiments. In this embodiment, the control operation is executed to decrease the vehicle height at the time of getting off the vehicle after the vehicle has come into a halt, so that the passenger is allowed to easily get off the vehicle or to unload baggage from the vehicle. The control operation at the time of getting off the vehicle may be attained as shown in a flowchart of FIG. 6.

At step S410, first, it is determined whether the engine switch is operated by the driver of the vehicle 10 to stop the engine. When the engine is stopped by the driver of the vehicle, it is expected that the passenger may thereafter get off the vehicle. When it is determined that the engine is stopped, the routine proceeds to step S420 where a vehicle height decreasing signal is output to the vehicle height control device 9 to decrease the height of the vehicle 10. Thus, upon executing the control operation for decreasing the vehicle height based on the halt of the engine, the passenger is allowed to easily get off the vehicle or to unload baggage.

At step S430, it is determined whether the engine is started again based on a signal from the engine switch. This is because the driver may simply stop the engine in order to bring the vehicle 10 into a halt only temporarily. When it is determined at step S430 that the engine has restarted (started again), the routine proceeds to step S500 where a vehicle height increasing signal is output to the vehicle height control device 9 to increase the vehicle height, so that the vehicle is ready to start travelling.

On the other hand, when it is determined at step S430 that the engine has not been started again, the routine proceeds to step S440 where it is determined whether the door locking operation is effected based upon signals from the lock switches 6a2 to 6e2 in the doors 11 to 15. When the door lock operation is effected, it can be so regarded that the passenger has got off the vehicle and has unloaded baggage. In this case, it is confirmed whether the user holding the portable device 1 is in the outside of the vehicle based on the processing of steps S450 to S470, i.e., based on request signals transmitted from the exterior transmitters 2a to 2e and on a response signal returned from the portable device 1, with which the result of collation of the ID code is OK.

In this case, it may further be attempted to transmit a request signal from the interior transmitter 2f and to make sure that there is received no response signal in response thereto, with which the result of collation of the ID code becomes OK. This makes it possible to reliably prevent such an occurrence that the portable device 1 is left in the compartment.

When it is confirmed through the processings of steps S450 to S470 that the user holding the portable device 1 is on the outside of the compartment, the vehicle height increasing signal is output at step S480 to the vehicle height control device 9 to increase the vehicle height up to the initial position. At step S490, lock signals are output to the lock control units 5a to 5e to lock the doors 11 to 15.

According to the control operation at the time of getting off the vehicle as described above, a moment when the engine of the vehicle 10 is stopped is regarded to be a state where the passenger is attempting to get off the vehicle and, hence, the height of the vehicle is decreased. This enable the passenger to easily get off the vehicle and to unload baggage. When the user holding the portable device 1 gets off the vehicle and operates the lock switches 6a2 to 6e2 provided in the doors 11 to 15, the doors of the vehicle are locked and the vehicle height is increased up to the initial position. Therefore, the user holding the portable device 1 does not have to bear any burden for increasing the vehicle height up to the initial position.

Though many preferred embodiments are described, it should be noted that the embodiments are not limitative but may further be modified in a variety of ways including the following modifications.

In the above first to third embodiments, the control operation is executed to decrease the vehicle height when the user holding the portable device 1 has approached any one of the doors 11 to 15 or has operated any one of the door handles 6a1 to 6e1 of the doors. However, in a vehicle having a height which at its initial position is set to be relatively low and enabling the passenger to easily get in, the control operation may be executed to decrease the vehicle height concerning the rear door 15 only. That is, when the user holding the portable device 1 approaches the rear door 15 or when the door handle 6e provided in the rear door 15 is operated, the control operation may be executed to lower the vehicle height. This is because even a vehicle having a relatively small vehicle height at its initial position, in many cases, has an opening that is positioned relatively high when the rear door 15 is opened.

In the above embodiments, further, the exterior transmitters 2a to 2e are provided in the doors 11 to 15 of the vehicle 10. In the case of small vehicles, it is considered that the user holding the portable device 1 will, in many cases, sits on the driver's seat or on the assistant driver's seat. In this case, therefore, the exterior transmitters may be provided in the door at the driver's seat, in the door at the assistant driver's seat and in the rear door only, but may not be provided in the doors at the right and left rear seats.

In the above embodiments, further, the in-vehicle device in the vehicle possessed the collation ECU 4 and the body ECU 7. So far as the required functions are exhibited, however, these ECUs may be formed integrally together, or a further increased number of ECUs may be employed.

Further, the operation for instructing the unlocking of the doors and the operation for instructing the locking of the doors may be executed for separate operation units (door handles and lock switches) as in the above embodiments, or may be executed for a common operation unit.

What is claimed is:

1. A system for controlling vehicle-mounted equipment, the system comprising:
a portable device;
an in-vehicle device provided in a vehicle for executing mutual communication with the portable device by transmitting a request signal therefrom and receiving a response signal including an ID code from the portable device, the in-vehicle device collating the ID code included in the response signal with a registration code stored therein and controlling the vehicle-mounted equipment depending on a result of collation,
wherein the in-vehicle device includes:
a transmitter having a communication area around the vehicle to transmit the request signal to the portable device;
a receiver for receiving the response signal from the portable device;
a height adjusting device for adjusting a height of the vehicle; and
a control unit for decreasing the height of the vehicle at time of getting in the vehicle by outputting a height decreasing signal to the height adjusting device when the ID code is collated to be OK.

2. The system according to claim 1, wherein the transmitter transmits the request signal at a regular interval when the vehicle is parking in a state where doors are locked.

3. The system according to claim 2, wherein:
the in-vehicle device includes an unlock operation unit provided in the door and operable for instructing unlocking, and a lock/unlock control unit for locking or unlocking the door; and
the control unit, at the time of getting in the vehicle, outputs the height decreasing signal to the height adjusting device and outputs an unlocking signal to the lock/unlock control unit to unlock the door of the vehicle, when the result of collation of the ID code is OK and when the unlock operation unit is operated.

4. The system according to claim 2, wherein:
the control unit, at a time of getting in the vehicle, outputs the height decreasing signal to the height adjusting device only on condition that the result of collating the ID code is OK, and outputs a height increasing signal to the height adjusting device to increase the height of the vehicle up to the initial position when there is no longer received the response signal with which the result of collation of the ID code is OK in a state where the height of the vehicle has been decreased.

5. The system according to claim 1, wherein:
the in-vehicle device includes an unlock operation unit provided in the door and operable for instructing unlocking, and a lock/unlock control unit for locking or unlocking the door;
the transmitter transmits the request signal when the unlock operation unit is operated; and
the control unit, at a time of getting in the vehicle, outputs the height decreasing signal to the height adjusting device and outputs an unlocking signal to the lock/unlock control unit to unlock the door, when the result of collation of the ID code is OK.

6. The system according to claim 1, wherein:
the in-vehicle device includes a detector for detecting a passenger who has got in the vehicle; and
the control unit, at a time of getting in the vehicle, outputs a height increasing signal to the height adjusting device to increase the height of the vehicle up to an initial position, when the detector detects a passenger who has got in the vehicle.

7. The system according to claim 1, wherein:
the in-vehicle device includes a detector for detecting a locked or unlocked state of the door; and
the control unit, at a time of getting in the vehicle, outputs a height increasing signal to the height adjusting device to increase the height of the vehicle up to an initial position, when the detector detects the door of the vehicle that has shifted from the unlocked state to the locked state.

8. The system according to claim 1, wherein the transmitter has an area at least around a rear part of the vehicle for communication with the portable device.

9. A system for controlling vehicle-mounted equipment, the system comprising:
a portable device;
an in-vehicle device provided in a vehicle for executing mutual communication with the portable device by transmitting a request signal therefrom and receiving a response signal including an ID code from the portable device, the in-vehicle device collating the ID code included in the response signal with a registration code stored therein and controlling the vehicle-mounted equipment depending on a result of collation,
wherein the in-vehicle device includes:
a transmitter having a communication area around the vehicle to transmit the request signal to the portable device;
a receiver for receiving the response signal from the portable device;
a lock operation unit provided in a door of the vehicle and operable for instructing locking;
a lock/unlock control unit for locking or unlocking the door of the vehicle;
a vehicle height adjusting device for adjusting a height of the vehicle; and
a control unit for decreasing the height of the vehicle at a time of getting off the vehicle by outputting a height decreasing signal to the height adjusting device when an engine of the vehicle is stopped,
wherein the control unit further increases the height of the vehicle up to an initial position by outputting a height increasing signal to the height adjusting device and locks the door of the vehicle by outputting a lock signal to the lock/unlock control unit, when the lock operation unit is operated and a result of collation of the ID code is OK.

10. The system according to claim 9, wherein the control unit decreases the height of the vehicle at a time of getting in the vehicle by outputting the height decreasing signal to the height adjusting device, when the ID code is collated to be OK.

11. A method for controlling vehicle-mounted equipment through communication between a portable device carried by a user and an in-vehicle device, the equipment including a height adjusting device for adjusting a height of a vehicle, the method comprising:
determining whether the portable device approaching the vehicle is an authorized one based on the communication between the portable device and the in-vehicle device;
driving the height adjusting device to decrease the height of the vehicle from an initial position before the portable device gets in the vehicle, when the portable device is determined to be the authorized one.

12. The method according to claim 11 further comprising:
determining whether the portable device has got in the vehicle; and
driving the height adjusting device to return the height of the vehicle to the initial position, when the portable device is determined to have got in the vehicle.

13. The method according to claim 11 further comprising:
determining whether a predetermined door unlocking operation to get in the vehicle is made by the user of the portable device,
wherein the driving drives the height adjusting device to decrease the height only when the predetermined door unlocking operation is determined to have been made.

14. The method according to claim 11 further comprising:
determining whether an engine of the vehicle is stopped,
wherein the driving drives the height adjusting device to decrease the height when the engine is determined to have been stopped.

15. The method according to claim 14 further comprising:
determining whether the portable device has got out of the vehicle,
wherein the driving drives the height adjusting device to return the height to the initial position, when the portable device is determined to have got out of the vehicle.

16. A method for controlling vehicle-mounted equipment through communication between a portable device carried by a user and an in-vehicle device, the equipment including a height adjusting device for adjusting a height of a vehicle, the method comprising:
determining whether an engine of the vehicle has stopped;
driving the height adjusting device to decrease the height of the vehicle from an initial position, when the engine is determined to have stopped;
determining whether the portable device has got out of the vehicle based on the communication between the portable device and the in-vehicle device; and
driving the height adjusting device to return the height of the vehicle to the initial position, when the portable device is determined to have got out of the vehicle.

17. The method according to claim 16 further comprising:
determining whether the engine has been restarted,
wherein the driving drives the height adjusting device to return the height to the initial position, when the engine is determined to have been restarted.
